(19) United States
(12) Patent Application Publication
(10) Pub. No.: US 2014/0017356 A1
(43) Pub. Date: Jan. 16, 2014

(54) METHOD FOR PROVIDING A WHOLE GRAIN CEREAL BASED EXTRACT

(71) Applicants: Rob Te Biesebeke, Bavois (CH); Michael Walters, Rivaz (CH); Nicolas Marjanovic, Pully (CH); Stefan Haas, Singapore (SG)

(72) Inventors: Rob Te Biesebeke, Bavois (CH); Michael Walters, Rivaz (CH); Nicolas Marjanovic, Pully (CH); Stefan Haas, Singapore (SG)

(73) Assignee: NESTEC S.A., Vevey (CH)

(21) Appl. No.: 14/007,090

(22) PCT Filed: Mar. 22, 2012
(86) PCT No.: PCT/EP2012/055050

§ 371 Date: Sep. 24, 2013

(30) Foreign Application Priority Data
Mar. 24, 2011 (EP) 11159604.5

(51) Int. Cl. A23L 2/38; A23L 1/105

(52) U.S. Cl. CPC A23L 2/382; A23L 1/1055
USPC 426/28; 426/618; 426/590; 426/580; 426/599

(57) ABSTRACT

The present invention relates to a process for preparing a whole grain cereal based extract having improved suspension properties. The process comprises the steps of: (i) providing a whole grain cereal; (ii) subjecting the whole grain cereal to a first grinding; (iii) subjecting the ground whole grain cereal to an hydrolysis of the macromolecular elements providing a modified whole grain cereal; (iv) separating a soluble fraction of the modified whole grain cereal from an insoluble fraction of the modified whole grain cereal; and (v) subjecting the insoluble fraction of the modified whole grain cereal to a second grinding and/or enzymatic modification obtaining a cereal based fraction having improved suspension properties, and comprising particles having a particle size of at the most 100 μm, such as at the most 50 μm, e.g. at the most 30 μm; and (vi) reincorporating at least part of the cereal based fraction obtained from step (v) into at least part of the soluble fraction obtained from step (iv) obtaining the whole grain cereal based extract.

### TECHNICAL FIELD OF THE INVENTION

The present invention relates to a process for preparing a whole grain cereal based extract. In particular the present invention relates to the preparation of a beverage comprising a beverage ingredient comprising the whole grain cereal based extract, which whole grain cereal extract maintain the nutritional value of the whole grain cereal and which makes it possible to provide the desired organoleptic properties of a beverage.

### BACKGROUND OF THE INVENTION

Extracts of cereals such as malt extract have been used as an ingredient in beverages, such as in cocoa malted beverages. Malt extract, an example of a cereal extract, was produced based upon the classic process used by breweries for making beer. In this process cereals such as barley or wheat are harvested and dried so that they can be stored until required for use. The traditional malting process involves steeping the grain in water, germinating the grain for a period of days and stabilising the grain by carefully drying it to a low moisture content typically around 5% moisture. During the malting process enzymes for converting the starchy endosperm to soluble components are produced. Enzymes such as a-amylase, b-amylase, b-glucanase, proteases, arabinoxylanases are synthesised in the germinating grain. During malting these enzymes also modify the structure of the cell wall allowing easier and more complete extraction of the soluble fraction of the cereal during later steps in the process.

The malted whole grain cereal is typically ground by milling to a heterogeneous powder where it is mixed with water in a ratio of 3-10 (or sometimes even more) parts water to 1 part grain. The initial temperature of the water may be around 40° C. to 50° C. to allow hydrolysis by proteases and cell-wall hydrolysing enzymes. Once this hydrolysis is sufficiently complete the temperature is raised to between 60° C. and 70° C. to allow hydrolysis of the starch by the α- and β-amylases. Once the hydrolysis is complete the temperature of the slurry is increased to around 80° C. to inactivate the enzymes. The slurry is passed through a separating device such as a lauter tun, decanter or plate and frame filter. The liquid portion is separated from the insoluble/partially soluble material by a process of filtration and leaching. Leaching involves washing the insoluble grain until all of the easily soluble material has been removed. The liquid portion is stabilised by drying to a powder or evaporating to a paste with typical dry-matter content above 78% (w/w).

The powder or paste obtained may be used as an ingredient in the beverage. The residual insoluble material (spent grain) is typically sold as animal feed or disposed in land fill.

Recently beverages have been described that utilise cereals by simply adding finely milled cereals, cereal flour and physically modified cereals such as flakes, pellets etc. The cereal content in these drinks is restricted due to impact on organoleptic properties and difficulty in dissolving or suspending the cereals into the drink. The resulting beverage can become highly viscous resembling more a smoothie than a drink or develop sediments or layers of cereal floating on the surface.

U.S. Pat. No. 5,135,765 describes a process for producing a protein-rich product and/or a fibrous product which includes the steps of pressing brewer's spent grain in a wet state, and sieving water from the pressed brewer's spent grain in order to separate it into a protein-containing fraction and a fibrous fraction. U.S. Pat. No. 5,135,765 describe that fine grinding of the fibrous material should be prevented because it may lead to difficulties in the subsequent separation of the protein fraction from the fibrous fraction. Furthermore, U.S. Pat. No. 5,135,765 describe that the fibrous fraction obtained is used as feed or as a combustible fuel.

U.S. Pat. No. 4,282,319 describes a process for the preparation of hydrolyzed products from whole grain, and such derived products. U.S. Pat. No. 4,282,319 describe the use of a proteolytic enzyme to transform water insoluble proteins into water-soluble products, and further to treat the starch contents with an amylase to form water-soluble starch products. The product is further treated by removing the bran fraction and removing water to obtain a dry, semimoist, or liquid but concentrated derived product. The product is to be added as a sweetening agent in food products as bread, drinks, and cereal products, whereby the bran obtained can be used in bread as fibre additive. Thus, U.S. Pat. No. 4,282,319 does not describe a fibre comprising beverage ingredient that maintains the nutritional value of the whole grain cereal and which makes has improved suspension properties.

The products and processes described above is associated with the following drawbacks:
From the traditional cereal extract approach, as described above, a portion of the cereal is not used in the beverage, but rather sold as animal feed. This unused portion comprises a range of value added nutritional components such as fibres, proteins, polypeptides or amino acids, vitamins and minerals.
A further drawback of the traditional cereal extract is that it is especially unsuitable for cereals that generate a large portion of insoluble material after hydrolysis, such as barley and wheat.
An even further drawback is the action of simply adding e.g. milled cereals or cereal flakes, because these ingredients tend to result in a beverage with a increased viscous texture due to swelling of the fibres and separation of the cereal components as sediments and/or floaters on the surface of the beverage.

Hence, there is a need for providing a method and a beverage ingredient where the nutritional value of the whole grain cereal is maintained or close to being maintained, where the suspension properties of the beverage ingredient are improved and/or which makes it possible to provide a beverage with the desired organoleptic properties.

### SUMMARY OF THE INVENTION

Accordingly, the above problems described above are solved by the present invention.

Thus, one aspect of the invention relates to a process for preparing a whole grain cereal based cereal extract; said process comprises the steps of:
(i) providing a whole grain cereal;
(ii) subjecting the whole grain cereal to a first grinding;
(iii) subjecting the ground whole grain cereal to an hydrolysis providing a modified whole grain cereal;
(iv) separating a soluble fraction of the modified whole grain cereal from an insoluble fraction of the modified whole grain cereal;
(v) subjecting the insoluble fraction of the modified whole grain cereal to a second grinding and/or enzymatic modification and/or chemical modification obtaining the cereal based fraction, the cereal based fraction comprising particles having a particle size of at the most 100 μm, such as at the most 50 μm, e.g. at the most 30 μm; and
(vi) reincorporating at least part of the cereal based fraction obtained from step (v) into at least a part of the soluble fraction obtained from step (iv) obtaining the whole grain cereal based extract.

Another aspect of the present invention relates to a whole grain cereal based extract obtainable from the above process.

Yet another aspect of the present invention is to provide a beverage ingredient comprising a cereal based fraction issued from the modification of the insoluble part of a grinded and hydrolysed whole grain cereal, said cereal based fraction comprising particles having a particle size of at the most 100 μm, such as at the most 50 μm, e.g. at the most 30 μm and residual starch level of at the most 20% (w/w) starch, such as at the most 5% (w/w) starch, e.g. at the most 3% (w/w) starch, such as at the most 2% (w/w) starch, e.g. at the most 1% (w/w) starch.

Still another aspect of the present invention is to provide a process for preparing a beverage having improved organoleptic and/or improved nutritional value, said process comprises the steps of:
(a) providing a beverage ingredient according to the present invention,
(b) mixing the beverage ingredient of step (a) with a liquid component, and obtaining the beverage.

An even further aspect of the present invention is to provide a beverage consisting of:
(1) a liquid component; and
(2) a beverage ingredient according to the present invention.

### BRIEF DESCRIPTION OF THE FIGURES

FIG. 1 shows the process according to the present invention outlined in the flowchart illustrated.

FIG. 2a shows the processing steps of the insoluble fraction in order to obtain an insoluble fraction having improved suspension properties good organoleptic properties. In this case wet spent grain is subjected to enzymatic modification and/or second grinding and/or chemical modification,

FIG. 2b shows the particle size distribution of the particles present in the insoluble fraction. Line 1 indicates a traditional produced insoluble fraction comprising particles having a particle size above 100 μm. Lines 2 & 3 indicates an insoluble fraction comprising particles having a particle size below 100 μm and produced in accordance with the present invention with the second grinding (or milling).

The present invention will now be described in more detail in the following.

### DETAILED DESCRIPTION OF THE INVENTION

The inventors of the present invention have surprisingly found that by treating a whole grain cereal in a special manner it becomes possible to improve the suspension properties of the insoluble fraction without compromising the organoleptic properties. This reduction in suspension properties may result in the insoluble fraction becomes more suitable as a beverage ingredient. By reincorporating the processed insoluble fraction in the process for obtention of a whole grain cereal based extract it is possible to provide a beverage having specially desired organoleptic properties. Higher amount of whole grain cereals may be added to the beverage because the suspension properties of the beverage ingredient are improved and the reduced size of the insoluble fraction results in a reduced influence on the viscosity of the beverage.

Thus in a first aspect the invention relates to a process for preparing a whole grain cereal based extract having improved suspension properties, said process comprises the steps of:
(i) providing a whole grain cereal;
(ii) subjecting the whole grain cereal to a first grinding;
(iii) subjecting the ground whole grain cereal to an hydrolysis providing a modified whole grain cereal;
(iv) separating a soluble fraction of the modified whole grain cereal from an insoluble fraction of the modified whole grain cereal;
(v) subjecting the insoluble fraction of the modified whole grain cereal to a second grinding and/or enzymatic modification and/or chemical modification obtaining the cereal based fraction having improved suspension properties, the cereal based fraction comprising particles having a particle size of at the most 100 μm, such as at the most 50 μm, e.g. at the most 30 μm; and
(vi) reincorporating at least part of the cereal based fraction obtained from step (v) into at least a part of the soluble fraction obtained from step (iv) obtaining the whole grain cereal based extract.

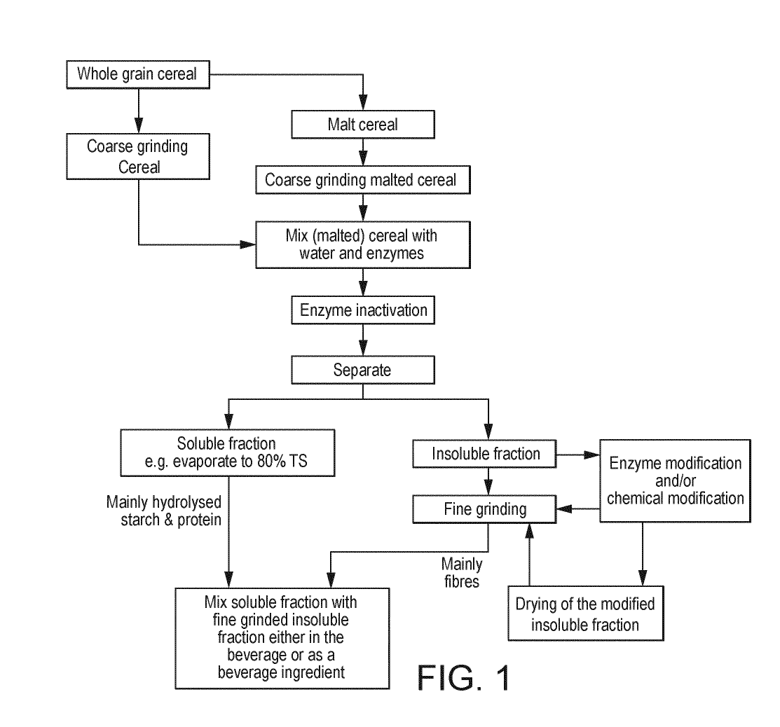

The process according to the present invention may be outlined as shown in the flowchart in FIG. 1. The process illustrated begins with a whole grain cereal which may be first ground or the whole grain cereal may be allowed to malt before it is subjected to first grinding.

It is to be intended by the term “grinding”, any physical destruction of the whole grain with the purpose to have the macromolecular structure of the whole grain available, for example to water and/or enzymes.

The ground (malted) whole grain cereal may then be mixed with water and optionally enzymes in order to modify the whole grain cereal. When the whole grain cereal has been sufficiently modified the enzymes are inactivated and the insoluble fraction of the whole grain cereal may be separated from the soluble fraction of the whole grain cereal. The insoluble fraction of the whole grain cereal may then be further ground, this ground being called second ground, and optionally the insoluble fraction of the whole grain cereal is subjected to a second enzymatic modification and/or a chemical modification before, after or at the same time as being further ground, second ground. The insoluble fraction of the whole grain cereal may be dried before it is subjected to further grinding, second grinding. The processed insoluble fraction is called cereal based fraction. Suitable amount of cereal based fraction is reincorporated in suitable amount of soluble fraction in order to obtain the whole grain cereal based extract. In the present case, suitable amounts of the soluble fraction and suitable amount of the second ground insoluble fraction, also called cereal based fraction, are mixed in order to provide a beverage ingredient or is mixed directly into the beverage.

In an embodiment of the present invention the soluble fraction (or a fraction hereof) and the cereal based fraction (or a fraction hereof) are derived from different whole grain cereals. Thus, the soluble fraction and the cereal based fraction do not necessarily have to come from the same whole grain.

In an embodiment of the present invention the cereal based fraction is incorporated in a soluble fraction comprising:
the soluble fraction obtained from separation of soluble/insoluble fraction of the modified whole grain cereal, and
a soluble fraction derived from different whole grain cereals.

A fraction of the soluble fraction and the cereal based fraction then comprise elements derived from different whole grain cereals.

Thus, the soluble fraction and the cereal based fraction do not necessarily have to come from the same whole grain.

In the present context the term “suitable amounts” relates to the amount of the soluble fraction and the second ground insoluble fraction to be mixed in order to achieve the desired organoleptic properties of the beverage. Thus, the term “suitable amounts” depend on the application and the beverage provided.

Several advantages of having a cereal based fraction with improved suspension properties exist:
I. An increase in whole grain cereal and fiber content may be provided in the final product, e.g. the beverage, while the organoleptic parameters of the product are substantially not affected;
II. The nutritional value of the whole grain cereal may be preserved;
III. Greater sense of satiety substantially without affecting the organoleptic parameters of the product and slower digestion. Currently, there are limitations for enriching beverages with whole grain due to non-flowable viscosity, grainy texture, and taste issues. However, the use of whole grain cereals treated according to the present invention in beverages allow for providing the desired viscosity, desired organoleptic parameters, a smooth texture, minimal flavor impact, and added nutritional health and wellness values;
IV. An additional advantage may be to improve the carbohydrate profile of the final products by replacing traditional externally supplied sweeteners such as glucose syrup, high fructose corn syrup, invert sugar, maltodextrine, sucrose, fiber concentrate, etc. with a more wholesome sweetener source.

In the present invention the term “whole grain cereal based extract” relates to an extract obtained from treating cereals by the process according to the present invention. Preferably, the whole grain cereal base extract comprises at least part of the insoluble fraction of the whole grain cereal.

In the present invention the term “cereal based fraction” relates to a fraction obtained from treating the insoluble fraction of a modified whole grain cereal by the process presented in the present invention. Preferably, the cereal based fraction comprises the insoluble fraction of the whole grain cereal.

In the present context the term “insoluble fraction” relates to a fraction obtained from the whole grain cereal comprising the insoluble fibres, i.e. the insoluble dietary fibres that are not fermented in the large intestine or only slowly digested by the intestinal microflora. Examples of insoluble fibres include celluloses, hemicelluloses, resistant starch type 1 and lignins. Further benefits of insoluble fibres include promotion of the bowel function through stimulation of the peristalsis, which causes the muscles of the colon to work more, become stronger and function better. There is also evidence that consumption of insoluble fibres may be linked to a reduced risk of gut cancer.

Dietary fibres are the edible parts of plants that are not broken down by digestion enzymes. Dietary fibres are fermented in the human large intestine by the microflora. There are two types of fibres: soluble fibres and insoluble fibres. Both soluble and insoluble dietary fibres can promote a number of positive physiological effects, including a good transit through the intestinal tract which helps to prevent constipation, or a feeling of fullness. Health authorities recommend a consumption of between 20 and 35 g per day of fibres, depending on the weight, gender, age and energy intake.

In contrast to the insoluble fraction there is the soluble fraction which is obtained from the process described by the present invention. The soluble fraction comprises the soluble fibres and the other soluble parts of the whole grain, e.g. proteins, vitamins, minerals, sugars, etc.

In the present context “soluble fibres” may also include dietary fibres that undergo complete or partial fermentation in the large intestine. Examples of soluble fibres from cereals include beta-glucans, arabinoxylans, arabinogalactans and resistant starch type 2 and 3, and oligosaccharides deriving from the latter. Soluble fibres from other sources include pectins, acacia gum, gums, alginate, agar, polydextrose, inulins and galacto-oligosaccharides for instance. Some soluble fibres are called prebiotics, because they are a source of energy for the probiotics present in the large intestine. Further benefits of soluble fibres include blood sugar control, which is important in diabetes prevention, control of cholesterol, or risk reduction of cardiovascular disease.

In an embodiment of the present invention the soluble fraction may be a malt extract.

The starting material in the present process may be a whole grain cereal. Whole grain cereal is a product made from cereal grains comprising the entire edible parts of a grain, i.e. germ, endosperm and bran.

In an embodiment of the present invention the whole grain cereal may be provided from whole grain cereal, a cereal product as disclosed in EP 0 031 050, liquid whole grain (LWG), milled whole grain cereal or cereal flour or any combination thereof.

In the present context the term “cereal” relates to monocotyledonous plants of the Poaceae family (grass family) cultivated for their edible, starchy grains.

In an embodiment of the present invention the whole grain cereal is selected from the group consisting of barley, brown rice, wild rice, bulgur, corn, millet, oat, sorghum, spelt, triticale, rye, wheat, wheat berries, teff, canary grass, Job's tears, fonio and pseudocereals. Plant species that do not belong to the grass family, but also produce starchy seeds or fruits that may be used in the same way as cereal grains, are called pseudocereals. Examples of pseudocereals include amaranth, buckwheat, tartar buckwheat and quinoa.

In yet an embodiment of the present invention the terms “cereal” and/or “whole grain cereal”, include both cereal and pseudocereals. Preferably, the terms “cereal” and/or “whole grain cereal” does not include pseudocereals.

In a preferred embodiment of the present invention the whole grain cereal is a malted whole grain cereal.

One advantage of the insoluble fraction provided by the process described in the present invention may be that the suspension properties of the insoluble fraction are improved. This improvement is considered relative to the suspension properties of an unprocessed insoluble fraction, e.g. having a main particle size above 100 μm.

In the present context the term “suspension properties” relate to the extent the insoluble fraction are to be suspended in a liquid phase. Normally the insoluble particles are dispersed throughout the liquid phase by e.g. mechanical agitation, stirring or shaking. Suspensions are solutions where the insoluble fraction eventually settles or at least part of the insoluble fraction eventually settles over time if left undisturbed

In a preferred embodiment of the present invention the insoluble fraction of the modified whole grain cereal after being subjected to a second grinding and/or enzymatic modification and/or a chemical modification, also called cereal based fraction, comprises particles having a particle size of at the most 100 μm, such as at the most 50 μm, e.g. at the most 30 μm

In order to control the organoleptic properties of the beverage and/or improve the nutritional value of the beverage, at least 50% of the insoluble fraction comprise particles having a particle size as mentioned above, such as at least 75% of the insoluble fraction comprise particles having a particle size as mentioned above, e.g. at least 90% of the insoluble fraction comprise particles having a particle size as mentioned above, such as at least 95% of the insoluble fraction comprise particles having a particle size as mentioned above, e.g. at least 98% of the insoluble fraction comprise particles having a particle size as mentioned above,

Preferably, the insoluble fraction of the modified whole grain cereal may be subjected to a second grinding, enzymatic modification or a chemical modification, more preferably the insoluble fraction of the modified whole grain cereal may be subjected to a second grinding and a chemical modification, even more preferably the insoluble fraction of the modified whole grain cereal may be subjected to a second grinding and enzymatic modification, even more preferably, the insoluble fraction of the modified whole grain cereal may be subjected to a second grinding and enzymatic modification and a chemical modification.

In an embodiment of the present invention the first grinding in step (ii) and/or the second grinding in step (v) is/are performed by use of a method selected from the group consisting of milling, ultrasound, micronisation, high pressure homogenisation, extrusion and combinations thereof.

Furthermore, water may be added to the first grinding of the whole grain cereal in order to make the grinding process more effective.

Following the first grinding process the ground whole grain cereal may be subjected to a hydrolysis of the macromolecular elements of the whole grain cereal. For example, the ground whole grain cereal may be subjected to a hydrolysis of carbohydrates and/or protein, and/or lipid, and/or other organic components (for example, polyphenols).

The first grinding may be a coarse grinding or a fine grinding. Preferably, the first grinding is a coarse grinding.

In an embodiment of the present invention the hydrolysis, for example, of carbohydrates and/or protein (in step (iii)), may be an enzymatic modification. Preferably, the enzymatic modification may be performed at a temperature in the range of 10° C.-122° C., preferably in the range of 20-100° C., such as in the range of 20-40° C. or in the range of 40° C.-65° C.

In yet an embodiment of the present invention the hydrolysis, for example, of carbohydrates and/or protein (in step (iii)), may be performed until substantially complete modification of the starch has taken place. The term “substantially complete modification” relates to at most 10% of the original starch content, may be remaining after modification, such as at most 5% e.g. at most 2% e.g. at most 1%, such as at most 0.5% of the original starch content, may be remaining after modification.

The hydrolysis, for example, of carbohydrates and/or protein in step (iii), may be performed by one or more endogenous enzyme(s) and/or by the addition of one or more exogenous enzyme(s) or by the combination thereof.

In respect of the one or more exogenous enzyme(s), such exogenous enzyme(s) may be selected from the group consisting of proteases, dextrinases, cell-wall hydrolyzing enzymes, amylases and amyloglucosidases, fragments thereof and any combination thereof. Preferably, a mixture of several of the above enzymes may be used

In order to preserve the nutritional value of the whole grain cereal at least one of the one or more exogenous enzyme(s) may be enzyme(s) showing no modifying activity towards dietary fibers when in the active state.

In an embodiment of the present invention at least one of the endogenous enzyme(s) and/or the exogenous enzyme(s) is a protease and/or an amylase. The protease may be active in alkaline, neutral and/or acid pH conditions.

In yet an embodiment of the present invention the proteases may be a metaloprotease, threonine protease, cysteine protease, aspartate protease, glutamic acid protease, serine protease or a combination hereof,

The amylase may preferably be an alpha-amylase, such as 1,4-α-D-glucan glucanohydrolase or glycogenase, a beta-amylase, such as 1,4-α-D-glucan maltohydrolase or saccharogen amylase, a gluco-amylase, such as amyloglucosidase or Exo-1,4-α-glucosidase or any combination hereof.

When the hydrolysis for example, of carbohydrates and/or protein, has reached a substantially complete modification the process may further comprise a step of inactivating the enzymatic activity. This inactivation may be performed by changing the temperature to a temperature in the range of 40-130° C., preferably in the range of 75-85° C. Preferably the inactivation may be performed for a period of time of at least 15 seconds, such as at least 30 seconds, e.g. at least 1 minute, such as at least 5 minutes, e.g. at the least 10 minutes, such as at least 20 minutes, e.g. at least 30 minutes.

Hydrolysis of the different macromolecular elements of the whole grain cereal can also be achieved by any other means known in the art, such as chemical modification, e.g. acid hydrolysis.

When the hydrolysis has ended and the soluble parts of the whole grain cereal have been liberated from the insoluble parts the soluble fraction and insoluble fraction may be separated. Thus, in an embodiment of the present invention the separation of the soluble fraction from the insoluble fraction (in step (iv)) may be selected from the group consisting of filtration, centrifugation, decanting and a combination thereof.

Depending on the application of the soluble fraction it may be further treated in order to provide different fractions comprising specific components or it may be concentrated. Preferably the soluble fraction obtained from the separation (in step (iv)) is concentrated. The concentrate may comprise at least of 10% and up to 97.5% (w/w) of the soluble fraction before concentration. The final concentrate may be in the form of a liquid, a gel or a powder.

The insoluble fraction obtained may also be subjected to further processing.

In an embodiment of the present invention the insoluble fraction of the modified whole grain cereal (obtained from the separation step (iv)) may be subjected to a second enzymatic treatment, a chemical treatment, a fermentation or a combination thereof before, during or after the second grinding (in step (v)).

The second grinding may be a coarse grinding or a fine grinding. Preferably, the second grinding is a fine grinding.

The further processing step may be a second enzyme treatment. Preferably, the second enzyme treatment is performed by one or more exogenous enzyme(s). In an embodiment of the present invention the one or more exogenous enzyme(s) is a cell-wall hydrolyzing enzyme, preferably selected from the group consisting of arabinoxylanases, beta-glucanases, cellulases, endoxylanase, including endo-1,4-β-xylanase, E.C.3.2.1.8, β-xylosidase, including xylan 1,4-β-xylosidase, E.C.3.2.1.37, α-glucuronidase, including α-glucosiduronase, E.C.3.2.1.139, α-arabinofuranosidase, including α-L-arabinofuranosidase, E.C.3.2.1.55, acetylxylan esterase, including E.C. 3.1.1.72, β-xylosidase and fragments thereof.

The outcome of the one or more exogenous enzyme(s) may be a change in the structural properties and/or improve functionality e.g. taste and nutritional properties of the whole grain cereal and/or the insoluble fraction.

The processed insoluble fraction obtained from the process described herein is called cereal based fraction. This cereal based fraction may preferably be used directly as a beverage ingredient.

In an embodiment of the present invention the beverage ingredient comprising a cereal based fraction. The cereal based fraction issued from the modification of the insoluble part of a grinded and hydrolyzed whole grain cereal, comprises particles having a particle size of at the most 100 μm, such as at the most 50 μm, e.g. at the most 30 μm and residual starch level of at the most 20% (w/w) starch, such as at the most 5% (w/w) starch, e.g. at the most 3% (w/w) starch, such as at the most 2% (w/w) starch, e.g. at the most 1% (w/w) starch.

In the present context the term “whole grain cereal based extract” relates to a whole grain cereal base extract comprising the insoluble fraction or a combination of the soluble fraction and the insoluble fraction. The desired organoleptic properties of a beverage may be obtained by mixing suitable amounts of the soluble fraction and the insoluble fraction. However, relative to traditionally produced beverages comprising whole grain cereals it is possible to add more whole grain cereals to the beverage if the whole grain cereals have been treated as described in the present invention. Thus, in an embodiment for the present invention the beverage ingredient comprises at least 50% (w/w) cereal based fraction, such as at least 60% (w/w), e.g. at least 75% (w/w), such as at least 85% (w/w), e.g. at least 90% (w/w), such as at least 95% (w/w), e.g. at least 98% (w/w).

In another embodiment of the present invention the beverage ingredient comprises 5-30% (w/w) dietary fibre, such as 8-25% (w/w) dietary fibre, e.g. 10-20% (w/w) dietary fibre, such as 12-17% (w/w) dietary fibre.

In yet another embodiment of the cereal based fraction comprises 25-75% (w/w) dietary fibres; 10-35% (w/w) protein and 10-35% (w/w) carbohydrate.

As mentioned above the whole grain cereal based extract may be a combination of both the soluble fraction and the insoluble fraction. In an embodiment of the present invention the beverage ingredient comprises at least 15% (w/w) of a soluble fraction of a modified whole grain cereal, such as at least 25%, e,g. at least 50%, e.g. at least 75%.

In an embodiment of the present invention the beverage ingredient comprises at most 70% (w/w) protein or fragments hereof, such as at the most 50% (w/w) protein or fragments hereof, e.g. at the most 20% (w/w) protein or fragments hereof, such as at the most 2% (w/w) protein or fragments hereof, e.g. at the most 1% (w/w) protein or fragments hereof

In another embodiment of the present invention the beverage ingredient comprises at least 5% (w/w) protein or fragments hereof, such as at least 10% (w/w) protein or fragments hereof, e.g. at least 25% (w/w) protein or fragments hereof, such as at least 50% (w/w) protein or fragments hereof, e.g. at least 60% (w/w) protein or fragments hereof.

It may be advantageous that the present beverage ingredient may be a high sugar beverage ingredient or a low sugar beverage ingredient. When the beverage is a high sugar beverage ingredient the beverage ingredient comprises above 50% (w/w) sucrose and at most 95% (w/w) sucrose, such as at most 85% (w/w) sucrose, e.g. at most 75% (w/w) sucrose, such as at most 65% (w/w) sucrose. When the beverage ingredient is a low sugar beverage ingredient the beverage ingredient comprises at most 50% (w/w) sucrose, such as at most 40% sucrose, e.g. at most 25% sucrose, such as at most 15% sucrose, e.g. at most 10% sucrose, such as at most 5% sucrose, e.g. 0% sucrose.

In order to control and/or improve the sensory impression of the beverage and the beverage ingredient the beverage ingredient comprises a flavour component. In an embodiment of the present invention the flavour component may be selected from the group consisting of cocoa, coffee, fruit, malt, soya, tea, vegetable, and any combination thereof.

The beverage ingredient may also comprise a fat component. In an embodiment of the present invention the fat component may be a vegetable fat component, a fish oil component or a combination thereof.

The beverage ingredient may further comprise a milk component, such as a skimmed milk component and/or milk component.

Depending on the application of the beverage ingredient and the production conditions, the beverage ingredient may be in the form of a liquid, a concentrate, a puree or a powder.

In an embodiment of the present invention the beverage ingredient comprises 25-45% (w/w) of a mixture of malt extract and cereal based fraction, preferably 34-38% (w/w), e.g. about 36% (w/w); 15-25% (w/w) of a skimmed milk powder, preferably 18-22% (w/w), such as about 20% (w/w); 10-20% (w/w) carbohydrate, preferably 14-18% (w/w), such as about 16% (w/w); 10-20% (w/w) cocoa, preferably 12-15% (w/w), e.g. about 13% (w/w) and 5-15% (w/w) of a fat component, preferably 8-12% (w/w), such as about 10% (w/w).

In the present case, malt extract may be considered as soluble fraction of the modified whole grain cereal.

In another embodiment of the present invention the beverage ingredient comprises 10-50% (w/w) of a mixture of malt extract and cereal based fraction, preferably about 30% (w/w); 15-45% (w/w) of a skimmed milk powder, preferably about 20% (w/w); 8-30% (w/w) sucrose, preferably about 15% (w/w); 5-30% (w/w) pure and soluble coffee, preferably about 9% (w/w) and 5-30% (w/w) creamer, preferably about 22% (w/w).

In another embodiment of the present invention the beverage ingredient comprises 10-50% (w/w) of a mixture of malt extract and cereal based fraction, preferably about 30% (w/w); 40-85% (w/w) sucrose, preferably about 50-70% (w/w); and 10-25% (w/w) cocoa, preferably about 15-20% (w/w).

In another embodiment of the present invention the beverage ingredient comprises 50-80% (w/w) of a mixture of a malt extract and cereal based fraction, preferably about 60% (w/w); 15-25% (w/w) skimmed milk powder, preferably about 20% (w/w); and 7-15% (w/w) fat, preferably about 10% (w/w).

The mixture of malt extract and cereal based fraction can be mixed in any proportion, preferably in a ratio to conserve the ratio found in the original whole grain cereal.

The beverage ingredient may preferably be used for the preparation of a beverage. In particular, the beverage ingredient may be used for the preparation of a beverage having improved organoleptic properties and/or an improved nutritional value.

This beverage may be prepared by:
(a) providing a beverage ingredient as described in the present invention,
(b) mixing the beverage ingredient of step (a) with a liquid component, and obtaining the beverage.

The liquid component may be any kind of consumable liquid component. Preferably, the liquid component may be selected from the group consisting of water, milk, fruit juice, vegetable juice or any combination thereof.

The milk component may be selected from the group consisting of whole milk, whey fractions, casein, any combination hereof

Hence, a beverage may be provided consisting of:
(1) a liquid component; and
(2) a beverage ingredient as described in the present invention.

In the present context the term “beverage” refers to a composition in the form of a dry powder, a slurry or a liquid. It is to be understood that the dry powder may be reconstituted in any applicable liquid suitable for consumption. The slurry or the liquid may be further diluted using any applicable liquid suitable for consumption.

Said beverage may comprise at least at least 5% (w/w) on a ready to drink basis of the soluble fraction of a modified whole grain cereal, such as at least 10% (w/w) on a ready to drink basis of the soluble fraction of a modified whole grain cereal, e.g. at least 20% (w/w) on a ready to drink basis of the soluble fraction of a modified whole grain cereal, such as at least 30% (w/w) on a ready to drink basis of the soluble fraction of a modified whole grain cereal, e.g. at least 50% (w/w) on a ready to drink basis of the soluble fraction of a modified whole grain cereal.

The concentration of the cereal based fraction may be at least 5% (w/w) of the beverage, on a ready to drink basis, such as at least 10% (w/w) of the beverage, on a ready to drink basis, e.g. at least 20% (w/w) of the beverage, on a ready to drink basis, such as at least 20% (w/w) of the beverage, on a ready to drink basis, e.g. at least 30% (w/w) of the beverage, on a ready to drink basis, such as at least 50% (w/w) of the beverage, on a ready to drink basis, e.g. at least 75% (w/w) of the beverage, on a ready to drink basis.

Furthermore, the beverage may have a concentration of protein or fragments thereof of at least 5% (w/w) of the beverage, such as at least 10% (w/w) of the beverage, e.g. at least 15% (w/w) of the beverage, such as at least 20% (w/w) of the beverage, e.g. at least 25% (w/w) of the beverage.

In an embodiment of the present invention the beverage may comprise 10-50% protein on a dry-matter basis; 5-30% fat by weight on a dry-matter basis of the beverage, 10-75% carbohydrate by weight on a dry-matter basis of the beverage and 5-30% cereal base fraction by weight on a dry-matter basis of the beverage.

In another embodiment of the present invention the beverage may have between 10-50% of the total energy from protein; between 5-30% of the total energy from fat, 10-75% of the total energy from carbohydrate and wherein the beverage comprises 5-30% cereal base fraction.

In yet another embodiment of the present invention the beverage may have at least 10% of the total energy of the beverage provided by protein, less than 30% of the total energy of the beverage provide by fat, at least 10% the total energy of the beverage provided by carbohydrates, and wherein the beverage comprises at least 5% of cereal base fraction.

Due to the possibility to increase the content of whole grain cereal in the beverage it is considered that the beverage is capable of bringing a health benefit to the consumer.

Such health benefit may be selected from improving the gastro-intestinal health, for providing a better immune system, for providing healthy aging, for reducing constipation, for lowering cholesterol, for reducing the incidence of cardiovascular diseases, for reduced obesitas, reducing the incidence of diabetes or any combination thereof.

In the present context the term “(w/w)” relates to a weight by weight ratio of a compound or product on a dry-matter basis unless any this else is stated.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1

### Dry Spent Grain with Good Organoleptic Properties

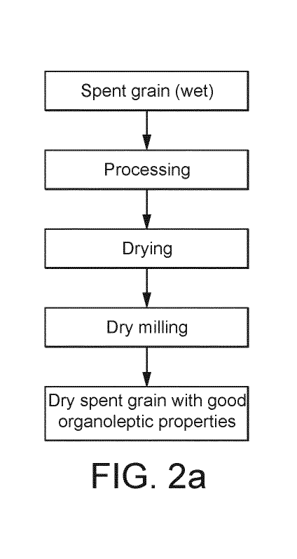

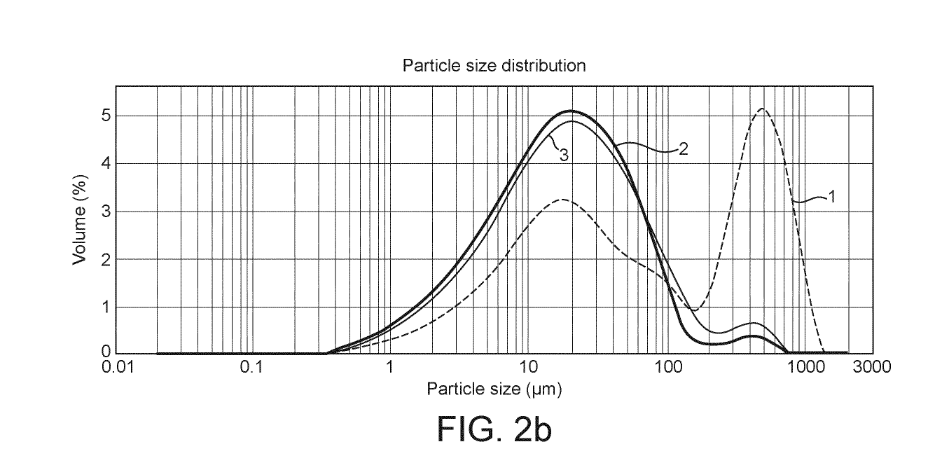

Wet spent grain was obtained as filtrate from a malted barley filtration process and undergoes a processing step which includes physically disruption eventually in combination with an enzymes treatment and/or chemically processing. This processing will have the goal to modulate the spent grain towards a preferred taste perception. After this processing, the wet spent grain is immediately dried to obtain a powder with an extended shelf-life compared to wet spent grain. The dried spent grain can be stored until further use or immediately used in dry milling to obtain the right particle size. The final dry spent grain processed according the present invention comprises particles having a particle size below 100 μm and has the right organoleptic properties (e.g. taste, mouthfeel, smell and sight) and a good shelf-life. The final dry spent grain processed according to traditionally methods comprises particles having a particle size above 100 μm and does not have the right organoleptic properties. The process for the preparation is illustrated in FIG. 2a.

A typical example of results of dry milling is as shown in FIG. 2b with regards to sample size distribution of the powder. The figure shows that >80% of the particles have a size of <50 micron which avoids a gritty mouth feel

### Example 2

### Spent Grain Coated Sugar

Wet spent grain obtained as filtrate from the malted barley filtration process undergoes wet milling in a ball mill until particles size is reduced below 100 μm, with more than 85% below 30 μm.

The micronized spent grain is then pasteurised by applying a heat treatment (95-100° C. for 30 minutes).

The micronized spent grain is then gradually spray-dry over a mixture of icing sugar and fine sugar (at a ratio 80/20) in a batch agglomerator (Mobatch from Heinen company).

The initial sugar quantity is 2.4 kg, and the micronized spent grains is progressively sprayed over the sugar, through a peristaltic pump, controlling the flow rate (˜45 g/minute).

The spray nozzle is installed in the mid-section of the agglomerator.

The air flow temperature varies between 95° C. and 105° C., with flowrate of 90-120 m2/hr.

The total agglomeration and drying time is two hours and the finish product (sugar coated with spent grains) has a moisture content of 1.3-1.5%.

### Example 3

### Cacao Beverage with Whole Grain Malt-Extract

A powder that is dosed at 15 g per 100 ml water and with 1 serving being defined as 28-30 gram. A powder containing 30-40% whole grain malt extract, as provided in example 2, (ideally 36%), 15-25% skimmed milk powder (ideally 20%), 10-20% sugar (ideally 16%), 10-20% cocoa (13%) and 5-15% fat (10%), of which the whole grain malt extract contains around 1-5% valorised spent grain which consists of ca. 50% insoluble fibers, ca. 25% protein and ca. 25% carbohydrates. The beverage has a caloric value below 255 kcal per serving and is intended to become consumed as a major part of the meal (e.g. breakfast).

### REFERENCES

U.S. Pat. No. 5,135,765
U.S. Pat. No. 4,282,319

1. A process for preparing a whole grain cereal based extract comprising the steps of:
(i) providing a whole grain cereal;
(ii) subjecting the whole grain cereal to a first grinding;
(iii) subjecting the ground whole grain cereal to a hydrolysis of macromolecular elements providing a modified whole grain cereal;
(iv) separating a soluble fraction of the modified whole grain cereal from an insoluble fraction of the modified whole grain cereal;
(v) subjecting the insoluble fraction of the modified whole grain cereal to a second grinding, a chemical and/or enzymatic modification obtaining a cereal based fraction, wherein the cereal based fraction comprises particles having a particle size of not more than 100 μm; and
(vi) reincorporating at least part of the cereal based fraction obtained from step (v) into at least part of the soluble fraction obtained from step (iv) obtaining the whole grain cereal based extract.

2. The process according to claim 1, wherein the whole grain cereal is a malted whole grain cereal.

3. The process according to claim 1, wherein the soluble fraction obtained from the separation in step (iv) is concentrated.

4. The process according to claim 3, wherein the concentrate comprises 10% to 97.5% (w/w) of the soluble fraction before concentration.

5. The process according to claim 1, wherein the insoluble fraction of the modified whole grain cereal obtained from the separation step (iv) is subjected to a second enzymatic treatment, a chemical treatment, a fermentation or a combination thereof before, during or after the second grinding in step (v).

6. A beverage ingredient comprising a cereal based fraction obtained by a modification of an insoluble part of a grinded and hydrolysed whole grain cereal, the cereal based fraction comprising particles having a particle size of not more than 100 μm and residual starch level of not more than 20% (w/w) starch.

7. The beverage ingredient according to claim 6, wherein the ingredient comprises, on a dry matter basis, 25-45% (w/w) of a cereal based fraction; 15-25% (w/w) of a skimmed milk powder; 10-20% (w/w) carbohydrate; 10-20% (w/w) cocoa; and 5-15% (w/w) of a fat component.

8. The beverage ingredient according to claim 6, wherein the ingredient comprises, on a dry matter basis, 10-50% (w/w) of a cereal based fraction; 15-45% (w/w) of a skimmed milk powder; 8-30% (w/w) sucrose; 5-30% (w/w) pure and soluble coffee; and 5-30% (w/w) creamer.

9. The beverage ingredient according to claim 6, wherein the whole grain mixture comprises 25-75% (w/w) dietary fibres; 10-35% (w/w) protein; and 10-35% (w/w) carbohydrate.

10. A process for preparing a beverage having improved organoleptic and/or improved nutritional value comprising the steps of:
providing a beverage ingredient comprising a cereal based fraction obtained by a modification of an insoluble part of a grinded and hydrolysed whole grain cereal, the cereal based fraction comprising particles having a particle size of not more than 100 μm and residual starch level of not more than 20% (w/w) starch,
mixing the beverage ingredient with a liquid component, and obtaining the beverage.

11. The method according to claim 10, wherein the liquid component is selected from the group consisting of water, milk, fruit juice, vegetable juice and combinations thereof.

12. A beverage consisting of:
a liquid component; and
a beverage ingredient comprising a cereal based fraction obtained by a modification of an insoluble part of a grinded and hydrolysed whole grain cereal, the cereal based fraction comprising particles having a particle size of not more than 100 μm and residual starch level of not more than 20% (w/w) starch.

13. The beverage according to claim 12, comprising on a dry matter basis: between 10-50% protein by weight of the beverage; 5-30% fat by weight of the beverage, 10-75% carbohydrate by weight of the beverage; and 5-30% cereal base fraction by weight of the beverage.

14. The beverage according to claim 12, wherein: between 10-50% of the total energy comes from protein; between 5-30% of the total energy comes from fat; 10-75% of the total energy comes from carbohydrate; and the beverage comprises 5-30% cereal base fraction.

15. The beverage according to claim 12, wherein: at least 10% of the total energy of the beverage is provided by protein, less than 30% of the total energy of the beverage is provide by fat, at least 10% the total energy of the beverage is provided by carbohydrates, and the beverage comprises at least 5% of cereal base fraction.
